(19) United States
(12) Patent Application Publication
(10) Pub. No.: US 2010/0038247 A1
(43) Pub. Date: Feb. 18, 2010

(54) Electrode Assembly, Use Thereof, and Method for the Production Thereof

(76) Inventors: Dirk Zimmermann, Frankfurt (DE); Ernst Bamberg, Frankfurt (DE); Ulrich Zimmermann, Waldbrunn (DE)

Correspondence Address: D. PETER HOCHBERG CO. L.P.A., 1940 EAST 6TH STREET, CLEVELAND, OH, 44114, US

(21) Appl. No.: 11/922,971

(22) PCT Filed: Jul. 3, 2006
(86) PCT No.: PCT/EP2006/006459

§ 371 Date: Oct. 15, 2008

(30) Foreign Application Priority Data
Jul. 1, 2005 (DE) 10 2005 030 859.7

(51) Int. Cl. G01N 27/26; B01D 57/02

(52) U.S. Cl. 204/547

(57) ABSTRACT

The invention relates to an electrode arrangement for the electrophysiologic analysis of biological cells and the like. The electrode arrangement comprises a contact area for contacting the electrode arrangement with a biological cell or the like as well as a terminal area for an external, electric contacting of the electrode arrangement. The contact area is formed with one or a plurality of electrode spike(s) which extend from the terminal area and comprise a geometrical shape which, in operation, allows an otherwise none-destructive penetration into a biological cell or the like through the membrane thereof into the interior thereof.

### CROSS-REFERENCE TO RELATED APPLICATION

This application is a National Stage application of International Application No. PCT/EP2006/006459, filed on Jul. 3, 2006, which claims priority of German application No. 10 2005 030 859.7 filed on Jul. 1, 2005.

### BACKGROUND OF THE INVENTION

The present invention relates to an electrode arrangement, the use thereof as well as—in particular electrochemical—methods for making the same.

For assaying and/or manipulating biological species or cells or the like, different methods and measurement or manipulation arrangements, respectively, are known.

On the one hand, contacting the membrane or species or cell from outside by attaching the respective species or cell to the electrode, is conceivable wherein a direct access to the interior of the species or cell or the like is not possible in this case since the membrane of the species or cell is not penetrated.

On the other hand, several patch- and voltage-clamp-technologies are known with the aid of which also an access to the interior of the species or cell is possible in order to manipulate and/or electrically sample them.

The disadvantages of the known methods are, on the one hand, the comparatively indirect sampling and the indirect access to the interior of the species or cell, and, on the other hand, a low reproducibility of the manipulations and of the corresponding measurement results as well as, further on, the instability of the arrangement out of the species or cell and the manipulating or measuring device and the stress of the species or cell itself.

### SUMMARY OF THE INVENTION

It is an object of the invention to provide an electrode arrangement for electro physiological assaying or analyzing biological species or cells or the like, a method for making the same as well as corresponding applications thereof, wherein the access to the interior of the species or cell may be implemented in a particularly simple, reliable, gentle and reproducible way.

The object, on which the invention is based, is achieved in an electrode arrangement according to the invention by means of the features of the independent patent claim 1. Furthermore, the object on which the invention is based, is achieved by a manufacturing method according to the invention having the features of the independent patent claim 43. Furthermore, the object on which the invention is based, is achieved by using the electrode arrangement of the invention according to the independent patent claims 54 and 55. Advantages of further developments are respectively subject to dependent sub claims.

In the sense of the invention, a biological cell can be, in narrower sense, a bacterium, a virus, an organelle, a liposome, a vesicle, a micellar structure, the components or fragments as well as the united structures or aggregates thereof, wherein also so called fusion species or fusion cells with regard to transverse and longitudinal fusion should also be included, are subsumed under a biological species or cell respectively. According to the invention each of these species can form a base of the respective system for the analysis or assay.

According to the present invention, an electrode arrangement for electrophysiological assaying, in particular of biological cells or the like, is provided. The electrode arrangement of the invention is formed with a contact area for contacting the electrode arrangement with at least one biological species, a biological cell or the like. Furthermore, a terminal area is formed for the external electric terminal of the electrode arrangement. The contact area is formed with an electrode spike or a plurality of electrode spikes as electrodes extending from the terminal area of the electrode arrangement. The electrode spikes are each formed with a geometrical shape which allows, during operation, the penetration of the electrodes spike into a biological species or cell or the like through its membrane into the interior thereof in an otherwise none destructive way.

It is, therefore, the basic concept to form the contact area with an electrode spike or a plurality electrode spikes in an electrode arrangement. The electrode spike or the plurality of electrode spikes are adapted to none destructively penetrate a membrane of the biological species, in particular of a biological cell, in order to obtain an access to the interior of the biological species or cell.

In a further development of the inventive electrode arrangement, it is provided that the electrode spike or the plurality of electrode spikes are formed to extend respectively from the terminal area tapering monotonously or exactly monotonously.

Alternatively or additionally, it can be provided that the electrode spike or the plurality of electrodes spikes are formed in a way in which they respectively extend cylindrical or square shaped from the terminal intern connection area and, at the distal end of the electrode spike or the plurality of electrode spikes, with a monotonously or exactly monotonously tapering tip. This means, in particular, that the electrode spike narrows down continuously from the proximal to the distal end in a monotonous way.

In another alternative or additional further development of the inventive electrode arrangement, it is provided that the electrode spike or the plurality of the electrode spikes are formed with a cross section which is round, circular, elliptical, rectangular or square.

In a preferred alternative or additional further development of the inventive electrode arrangement, it is provided that the electrode spike or the plurality of electrode spikes are formed with a first and proximal end facing the terminal area or forming the terminal area.

In an advantageous alternative or additional further development of the inventive electrode arrangement, it is provided that the diameter of the electrode spike or the plurality of electrode spikes at the proximal end is formed in the range of about 50 nm to about 5000 nm.

In a particularly preferred, alternative or additional further development of the inventive electrode arrangement, it is provided that the diameter of the electrode spike or the plurality of electrode spikes at the proximal end is below about 1/10 of the diameter of a species or cell to be contacted.

In a particularly advantageous, alternative or additional further development of the inventive electrode arrangement, it is provided that the electrode spike or the plurality of electrode spikes are formed with a second and distal end facing away from the terminal area.

In this case, according to another embodiment of the inventive electrode arrangement, it may provided therein that the diameter of the electrode spike or the plurality of the electrode spikes at the distal end is formed in the range of 1/10 of the diameter of a species or cell to be contacted.

In another preferred embodiment of the inventive electrode arrangement, it may be alternatively or additionally provided that the electrode spike or the plurality of electrode spikes at the distal end are formed with a radius of curvature in the range of about 5 nm to about 50 nm.

Therein, the radius of curvature of the electrode tip is, in particular, the radius of that ball which at best approximates the electrode spike at its distal end.

In a further advantageous embodiment of the inventive electrode arrangement, it may be alternatively or additionally provided that the electrode spike or the plurality of electrode spikes comprise, starting from the terminal area, a length in the range of about ⅘ of the diameter of a species to be contacted.

According to another preferred embodiment of the inventive electrode arrangement, it may be alternatively or additionally provided that the contact area is provides with a plurality of electrode spikes.

In another advantageous embodiment of the inventive electrode arrangement, it may be alternatively or additionally provided that that the electrode spikes are geometrically equal and/or equally functioning.

In another further development of the inventive electrode arrangement, it may be alternatively or additionally provided that the terminal area is formed as a materially continuous base with an upper surface and a bottom side.

In a further development of the inventive electrode arrangement, it may be alternatively or additionally provided that the electrode spike or the plurality of electrode spikes are formed to extend from the upper surface of the base.

In a particularly preferred further development of the inventive electrode arrangement, it may be alternatively or additionally provided that the electrode spike or the plurality of electrode spikes are formed to extend from the upper surface of the base per particularly or essentially per particularly, at least locally.

In another advantageous further development of the inventive electrode arrangement, it may be alternatively or additionally provided that the electrode spikes are formed to be aligned equally orientated and in parallel or essentially in parallel to each other, at least locally.

It is also conceivable that the electrode spikes according to another preferred embodiment of the inventive electrode arrangement are formed to be arranged alternatively or additionally in the form of a row matrix or a perpendicular matrix on the upper surface of the base.

It is also possible that the electrode spikes according to a further preferred embodiment of the inventive electrode arrangement, are formed to be arranged with equal pair wise distances of directly adjacent electrode spikes in the main access direction of their arrangement.

It is also conceivable that the upper surface of the base is formed planar, in particular, locally.

Furthermore it is possible that the base and the electrode spike or the plurality of electrode spikes are formed integrally with each other as an integral, material area.

In a preferred alternative or additional further development of the inventive electrode arrangement it is provided that the base and the electrode spikes or the plurality of electrode spikes are formed to be integrally connected to each other.

In an advantageous alternative or additional further development of the inventive electrode arrangement, it is provided that the base and the electrode spike or the plurality of electrode spikes are formed out of the same, in particular electrically conductive, material.

In a particularly preferred alternative or additional further development of the inventive electrode arrangement, it is provided that the electrode spike or the plurality of electrode spikes are formed as electrochemically etched structures.

In a particularly advantageous alternative or additional further development of the inventive electrode arrangement, it is provided that a carrier having an upper surface and a bottom side, is formed out of an electrically insolating material.

In this case, according to another embodiment of the inventive electrode arrangement, it is, herein, provided that the proximal ends of the electrode spikes and, optionally, the bases are embedded into the carrier and are formed truly below the upper surface of the carrier, and that the distal ends of the electrode spikes are formed truly above the upper surface of the carrier.

In another preferred embodiment of the inventive electrode arrangement, it may be alternatively or additionally provided that the upper surface of the carrier is formed running completely or locally in conformity and in particular in parallel to the upper surface of the base.

According to a particularly advantageous embodiment of the inventive electrode arrangement, it can be alternatively or additionally provided that upper surface of the carrier is formed completely or locally planar, convex and/or concave.

According to another preferred embodiment of the inventive electrode arrangement, is may be alternatively or additionally provided that the upper surface of the carrier is formed planar or as actually planar and with concave indentations in the area of the proximal end of the electrode spikes.

It is also possible that the bottom side of the base is formed at the bottom side of the carrier, at least in part uncovered by the carrier material in order to allow an external electric access.

It is also conceivable that a counter electrode arrangement and/or a reference electrode arrangement is/are formed electrically insulated with respect to the contact area and the terminal area.

The counter electrode arrangement may be formed with one or a plurality of counter electrodes.

The counter electrode arrangement or a part thereof and/or the reference electrode arrangement may be formed on the upper surface of the carrier.

In a particular advantageous further development of the inventive electrode arrangement, it may be alternatively or additionally provided that the spatial arrangement and/or the geometry of the counter electrode arrangement are formed for generating a controlled inhomogeneous electric and/or electromagnetic field.

In another advantageous further development of the inventive electrode arrangement, it may be alternatively or additionally provided that the counter electrode arrangement or a part thereof is formed to be opposite to the electrode spike or the plurality of electrode spikes.

It is also conceivable that the counter electrode arrangement or a part thereof is formed in a distance in the range of about 15 μm to about 1 cm from the electrode spike or the plurality of electrode spikes.

It is also conceivable that a counter electrode of the counter electrode arrangement is formed with a two-dimensional geometry.

In a particularly preferred alternative or additional further development of the inventive electrode arrangement, it is provided that the counter electrode of the counter electrode arrangement comprises a size and/or an area which are large in relation to the size/area of the electrode spikes, in particular in a ratio in the range of about 5:1 or in the range of about 100:1 or above.

The electrode spikes and/or the base my, for example, be formed out of a material or a combination of materials of the group consisting of silver, gold, platinum, tungsten, alloys, alloys of these metals, platinum-iridium-alloys and gold-iridium-alloys.

In an advantageous alternative or additional further development of the inventive electrode arrangement, it is provided that a plurality of bases is formed having one or a plurality of electrode spikes each.

It is also conceivable that the bases are formed individually or in groups, electrically insulated from each other and/or spatially separated from each other.

In a preferred alternative or additional further development of the inventive electrode arrangement, it is provided that, as a carrier, a material range is formed with or out of a material or a combination of materials of the group consisting of glasses, glass-like materials, organic polymers and photoresists.

Furthermore, a method for reducing the inventive electrode arrangement is provided by the present invention.

Therein, it is provided according to the invention that the electrode spikes or the plurality of electrode spikes are formed by an electrochemical etching method.

In a first further development of the inventive method for producing the inventive electrode arrangement, it is provided that the electrochemical etching is based on a single or plurality of fine wire(s).

This can preferably be affected using a bonding machine.

In another further development of the inventive method for producing the same inventive electrode arrangement, it is additionally or alternatively provided that the electrochemical etching method is based on fine wires having a diameter in the range of about 5 μm to about 50 μm. It is also conceivable to start with wires having a diameter in the range of about 300 μm to about 500 μm.

In a further additional or alternative embodiment of the inventive method for producing the inventive electrode arrangement, it is provided that the electrochemical etching method is based on fine wires out of a material or a combination of materials out of the group consisting of silver, gold, platinum, tungsten, alloys, alloys of these metals, platinum-iridium-alloys and gold-iridium-alloys.

It is conceivable that the electrochemical etching method is based on so-called bonding wires or wires corresponding in their properties to bonding wires.

In a particularly preferred embodiment of the inventive method for producing the inventive electrode arrangement, it is provided that, at first, one or several fine wire(s) are processed by a corresponding electrochemical etching method and that, thereafter, the wires processed in this way, are inserted into a holding device, in particular by holding the ends of the wires in the holding device of the ends of the wires designated as proximal ends for the electrode spikes, wherein, thereafter, the wire or the plurality of wires are integrated into an insulating material for a carrier.

Therein, as an insulating material for the carrier, for example a viscous polymer or glass can be used.

Furthermore, it is alternatively or additionally conceivable that the material for the carrier, and in particular the viscous polymer, is kept by the surface tension or by an external filed upon imbedding of the wire or the plurality of wires in the holding device.

In a further embodiment of the inventive method for producing the inventive electrode arrangement, it is additionally or alternatively provided that, after imbedding the wire or the wires by means of the insulating material for the carrier into the holding device, the wire or the wires are controlled micro-positioned in order to adjust thereby in particular the free length of the electrode spike to be formed or of the electrode spikes to be formed.

In another embodiment of the inventive method for producing the inventive electrode arrangement, it is additionally or alternatively provided that—in particular after the micro-positioning—the insulating material for the carrier, and in particular the viscous polymer, is cured, in particular by radiation, ultraviolet light, by raising the temperature and/or by physical and/or chemical processes.

It is also conceivable that, as an insulating material for the carrier, a glass is provided, and that, in particular after the micro-positioning, the glass is hardened by solidification by cooling.

Also methods using the inventive electrode arrangement and applications of the inventive electrode arrangements, are provided by the invention.

The inventive electrode arrangement can, according to the invention, be used for the electrophysiological assaying and/or manipulation of a species out of the group formed by biological cells, liposomes, vesicles, micellar structures, bacteria, viruses, fusion cells, organelles, genetic, molecular-biological and/or biochemical derivatives thereof, components of these species and united structures of these species.

The inventive electrode arrangement can, according to the invention, be used, also for micro injecting of a substance into a species out of a group formed by biological cells, liposomes, vesicles, micellar structures, bacteria, viruses, fusion cells, organelles, molecularbiologic and/or biochemical derivatives thereof, components of these species and united structures of these species.

In the latter case, the tip of the electrode or the tips of the electrode spikes are loaded, prior to the micro injection, with a substance to be injected.

The loading can happen in particular also by applying electric fields, for example in case of electrically charged substances, for example with DNA.

It is particularly advantageous if the electrode arrangement is provided embedded in a microstructure.

It is also conceivable that the electrode arrangement is provided in a lap-on-the-chip structure.

Furthermore, it is possible that the electrode arrangement is provided in or for an assay, in particular for high throughput applications.

It can also be provided in these usage occasions and applications that the species or a plurality thereof to be examined and/or processed, is supplied to the electrode spike or the plurality of electrode spikes while the electrode arrangement is at rest. Therein, it can be provided that the movement of the species to be examined and/or processed, to the electrode spike or the plurality of electrode spikes is effected by exerting a force to the respective species.

It is conceivable that the application of force is effected by a dielectrophoretic force.

Therein, it can be provided that the dielectrophoretic force is generated by an—in particular high frequency—inhomogeneous, alternating, electric field in between the electrode spike or the plurality of electrode spikes and the provided counter electrode arrangement having the counter electrodes.

Therein, it can be of an advantage that the electrode spikes are supplied with an alternating voltage in the range of about 10 mV to 300 V and/or in the frequency range of about 100 Hz or about 60 MHz, respectively, in order to generate the dielectrophoretic force.

It is alternatively or additionally conceivable that an electric cell cage for the micro-positioning of the species is used during the dielectrophoretic advance.

Furthermore, it can be additionally or alternatively provided for facilitating the contacting of the cell, that the cell to be contacted is firmly filled up by iso-osmolar solutions.

By means of stiffening reagents—for example by EDTA or pluronium—the membrane might be stiffened and the penetration of the electrode spike can be facilitated.

Furthermore, an electrode arrangement is proposed in which the counter electrode arrangement 50 or a part 51 thereof is formed according to one of the proceeding claims in order to allow in particular a dielectric contacting of biological cells in a kind of sandwich system in which the biologic cell to be examined allows a bridging between the two electrodes after an electric contact and fusion has been effected.

Also an electrode arrangement is proposed in which the counter electrode 51 of the counter electrode arrangement 50 comprises a size and/or a surface area which are large in relation to the size/surface of the electrode spike 40s, in particular in a ratio in the range of about 5:1 or in the range of about 100:1 and above, preferably in a range of about 10000:1.

Also an electrode arrangement is conceivable in which the electrodes are modified by means of a chemical reaction in such a way that an electrophysiological assaying of the biological cells is made possible, facilitated or more sensitive, wherein the chemical reaction is in particular mainly an electrochemical oxidation of the above mentioned metals with a halogen, wherein the chemical reaction happens, in time, in particular prior or after the contacting of the biological cell, wherein, in the latter case, the halogen is derived from the zytosol of the cell and/or supplied thereby.

Furthermore, an electrode arrangement can also be provided in which the electrode arrangement is combined with a pressure measurement probe, wherein, in particular, a pressure measurement probe is concerned which is arranged externally outside on the measurement subject or which is invasive and is located within the measurement subject.

Also, another use is provided in which the electrode spike 40s or the plurality of electrode spikes 40s is supplied with an alternative voltage in the range from about 10 mV to about 300 V and/or in the frequency range from about 100 Hz or about 100 MHz, respectively, preferably from about 100 Hz or about 60 MHz respectively, further preferred from about 100 Hz or about 40 MHz, respectively, in order to generate the dielectrophoretic force.

In another use, an electric insulation is not made with free electrodes contacted by cells, but in such a way that a solution of liposomes of a defined size, wherein the minimum diameter is 100 nm and the maximum diameter is 5 μm, is flashed across the electrode surface and is contacted to the above mentioned, free electrode spikes by applying an alternative current.

According to a further aspect of the present invention, a method for electrically contacting a species Z to be examined and/or processed, in particular a biological cell or the like, with an electrode spike 40s of an electrode arrangement 10 is proposed in which a patch pipette or a patch electrode is used as an electrode spike 40s or comprises the electrode spike 40s, and in which the electrode arrangement 10 is supplied with an electric field in a controlled way such that a dielectrophoretic force is exerted onto the species Z to be examined and/or processed in such a way that the species to be examined and/or to be processed, is moved to the electrode spike 40s and contacted therewith.

Therein, the electrode spike 40s or a plurality of electrode spikes 40s can be supplied with an alternating voltage in the range from about 10 mV to 300 V and/or in the frequency range from about 100 Hz or about 100 MHz, respectively, preferably from about 100 Hz or about 60 MHz, respectively, further preferred from about 100 Hz or about 40 MHz, respectively, in order to generate the dielectrophoretic force.

The focussing or contacting, respectively, of biological cells to be assayed electro-physiologically, it is carried out preferably dielectrically by modulating the frequencies, wherein the frequencies to be applied for this purpose, are in the range of at least 100 Hz to a maximum of 100 MHz, in particular in the range from 100 kHz to 40 MHz.

A particular embodiment provides for a combination of the above described electrode arrangement U.S.A. pressure measurement probe, wherein this refers to an external pressure measurement probe arranged outside on the measurement subject or an invasive pressure measurement probe arranged within a measurement subject.

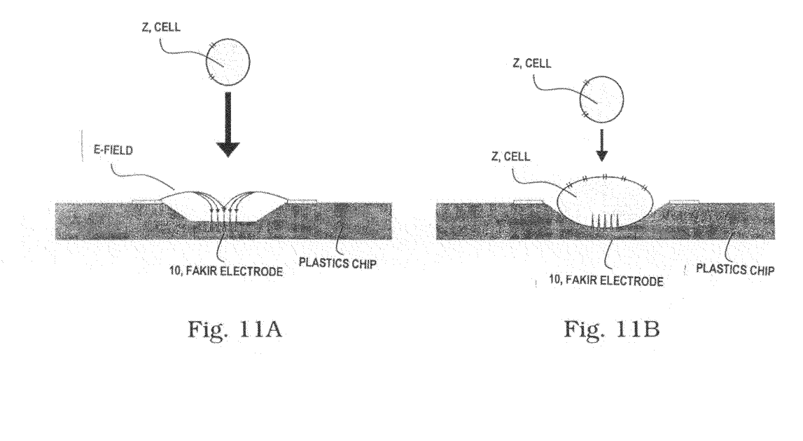

Also an electrode arrangement can be provided in which the counter electrode is also formed as a fakir electrode and allows, thereby, a dielectric contacting of biological cells in a fashion of a “sandwich” system, in which the biological cells to be examined allow a bridging between the two electrodes after the electric contact and fusion has been effected. This is shown in the FIGS. 11a and 11b as well as 12a and 12b.

An electrode arrangement is also conceivable in which the electrodes are modified by a chemical reaction in such a way that the electro-physiological assaying of the biological cells is made possible, facilitated or made more sensitive, wherein the above mentioned chemical reaction is mainly an electrochemical oxidation of the above mentioned metals with a halogen. This chemical reaction can happen, in time, prior or after the contacting of the biological cell. In the latter case, the halogen is derived/supplied from the zytosol of the cell.

A possible use is conceivable in which an electric insulation is carried out not with free electrodes contacted by cells in such a way that a solution of liposomes of defined size, wherein the minimum diameter is 100 nm and the maximum diameter is 5 μm, is flashed across the electrode surface and is contacted by applying an alternative current to the above mentioned, free electrode spikes.

The dielectrophoretic contacting may also be possible with a construction which is similar to a normal patch pipette. An electrode—designated with A in the following—which is surrounded by a micro-glass-capillary which is, in turn, filled with a physiologic solution. The force of attraction to the cell will happen—with an appropriate counter electrode B—in the direction of the electrode A. Thereby, the cell is uniformly accelerated in direction of the micro-glass-capillary and is “impaled” thereby.

These and further aspects of the present invention are further explained in the following:

In the following, the inventive electrode arrangement is also synonymously called fakir electrode. The invention, therefore, refers in particularly also to so-called fakir electrodes, the production thereof and the use thereof.

### Problem Posed

With the aid of electrophysiological techniques, the electric parameters of biological systems can be analyzed and manipulated. These techniques are applied to united cell structures, single cells, fragments of cell membranes and liposomes and proteo-liposomes, the latter among others by means of techniques which are based on so-called artificial membranes. In the following, the spectrum of biological systems is abbreviated as “cells”. It is common to all these electrophysiological techniques that they are used also for analyzing the functional characteristics or for manipulating, respectively, of (membrane) proteins and of the membranes surrounding those.

A decisive problem of the existing electrophysiological techniques, for example in voltage-current- and patch-clamp techniques, is that with these only a direct electric sampling is possible with cells starting from a defined size—for example with a diameter larger than 10 μm —, on the other hand, irreversible damages are caused on living cells by the microelectrodes. Furthermore, these techniques are unstable in case of mechanical exposure. This leads to a destruction of the cell after a short period of time. It can also be verified that all existing electrophysiological techniques have the severe disadvantage—in particular for commercial applications—that they are extremely complicated and that, thereby, an automation of the process control is elaborate and very much prone to errors.

The invention presented here, does not comprise the above mentioned disadvantage of existing techniques. It distinguishes by a high robustness, flexibility in the application and it allows an indirect as well as a direct (reversible) electric sampling on the inserted cells.

### Idee

The present invention presents, among others, in particular an electrophysiological measurement arrangement for cells, fusion cells, liposomes, membrane fragments and united cell structures—in the following simply subsumed as cells.

The electric manipulation of the cells takes place through one or several electrodes which directly penetrate into the cells. Therein, the size of the electrodes depends on the cellular system used. The electrode will have a very small diameter, for example in the range of about 900 nm, in case of very small cells-diameter in the range of 15 μm, and it will have a small length, for example in the range of about 5 μm. It is also important that the fakir electrodes have a fine tip, for example smaller than about 500 nm, in order to injure the cellular system as little as possible upon penetration.

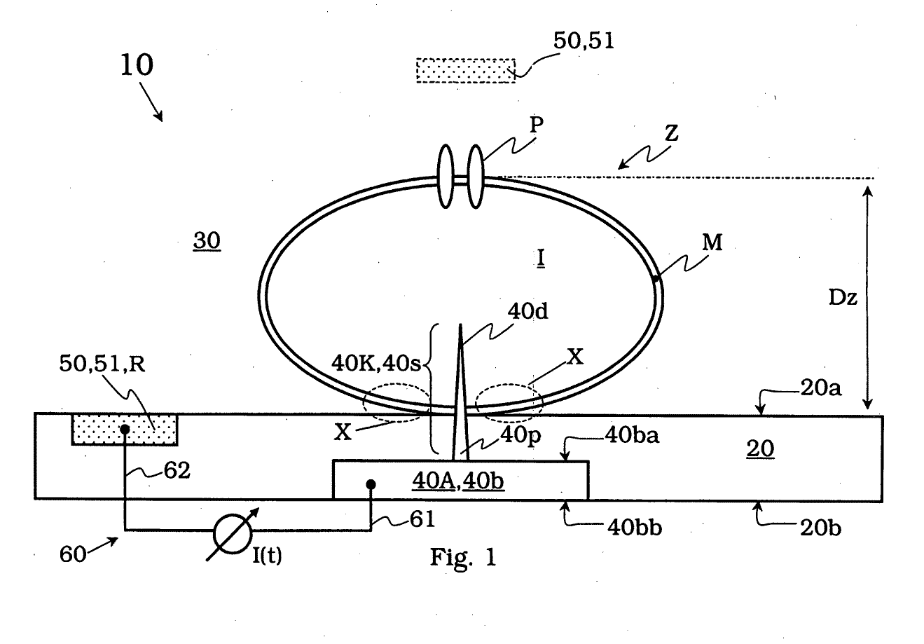

FIG. 1 shows a possible electrophysiological arrangement of the fakir technology proposed herein. The cell is shown as contacted by a fakir electrode with plural spikes.

### Methods of Producing the Fakir Electrode

Important characteristics of the fakir electrodes proposed here are in some embodiments:

a) their geometrical dimensions and/or

b) the electrically insulating carrier material for the electrode.

The exposed length of the electrode is determined by the carrier material. The production of such fakir electrodes out of nano-electrode-structures and carrier material is part of the invention presented here.

As explained in (1), the fakir electrodes used must have dimensions in their geometry as well as in their length in the order of nano-meters and micro-meters in some applications, and notably independent of the cellular system use:

The diameter has to be between about 50 nm and about 5000 nm, the length between about 500 nm and about 250 μm. The fakir electrodes consist out of conducting materials, preferably out of metals, out of silver, gold, platinum, tungsten and/or alloys as for example Pt—Ir and Au—Ir.

### Production Methods

The production should take place by means of electric or electrochemical etching, for example of fine wires, having a diameter of about 5 μm to about 50 μm for example, out of a corresponding metal or a corresponding alloy for example.

One aspect of the invention is the use of finest starting wires, for example of so called bonding wires or from wires which are similar in their characteristics because the etching process may be carried out more simple with small starting diameters and better results can be achieved. However, also wires having a larger diameter can be used as a starting material. This approach, however, makes the etching process more difficult. Metal wires having finest metal tips are obtained by the etching process. These tips of the metal wires etched in this way, are for example inserted into an appropriate holding device, for example into a ring, a grid or a cannula so that the wire may be surrounded by a viscous polymer. The viscous polymer is, therein, held in the holding device by means of surface tension or by means of fields. It is important in this connection that the wire is inserted into holding device before the polymer is added thereto. These has the consequence that the fine tip of the wire cannot come into contact with the polymer, and that, therefore, also no deposits of the electrically insulating polymer can be formed on the electrode.

Subsequently a micro-positioning of the metal wire in the polymer takes place so that the exposed length of the etched metal tip has the desired dimensions. Thereafter, the polymer is cured by means of ultraviolet light, by means of raising the temperature or by other physical/chemical processes. If needed, the position of the metal tip may be adjusted during the curing process.

The detection of the exposed tip takes place, therein, for example through visual control by a microscope or by an automatic process control by means of laser scanning or other measurement systems, respectively. The adjustment of the wire can take place manually or automatically, for example while referring back to the optical control or the laser scanning, respectively. Polymer materials are used which have a high viscosity, are subjected only to a small change of volume during the curing process and are adapted to be cured by ultraviolet light, temperature or other chemical/physical processes.

This process can also be carried out with a plurality of metal wires etched independently from each other. In this way, a “lawn” of electrically independent electrodes is obtained.

Also a production method with glass instead of a polymer is conceivable. Therein, the holding device can consist out of an electric spiral-shaped heating filament. This can be used in order to heat up and liquefy the glass such that the wire may be micro-positioned thereafter. The system can then furthermore include a supply system for liquid and heated glass so that also in this case the etched wire can, at first, be pushed through the holding device and that the exposed tip does not come into contact with the liquid glass.

### Contacting of Cells at Nano-Fakir-Electrodes

The above presented fakir electrodes are supposed to penetrate into cells so that these become adapted to be electrically sampled. It is part of the invention presented here that the electrodes are not brought to the cell as in a conventional system, but the cells are brought to the fakir electrode. This is supposed to be achieved by application of a dielectrophoretic force. This force can be generated through the application of heavily inhomogenous high frequency alternating fields, and it causes a migration of the cell in the direction of the fakir electrode in the case of appropriate dielectric characteristics of the cell—in relation to the dielectric characteristics of the medium. It only ends when the fakir electrode is in the interior of the cell. Thereafter, the cell is contacted with the fakir electrode. Theoretical explanation: With a constant field strength, the force increases with the inhomogeneity of the field so that with electric fields which exists between a spike and a planar reference electrode (that is the reason for the inhomogeneity of the field), the forces can get so large that the cell can be attracted to an atomic distance to the electrode. The force on the cell in such an inhomogeneous alternating field also strongly increases furthermore with a decreasing distance from the fakir electrode. This has the consequence that the contacting happens very fast and the penetration of the metal spike is a process which is relatively free of stress for the membrane of the cell. This finding which is confusing at a first glance can be deducted therefrom that the membrane is penetrated fast because of the speed of the approach to the spike and does hardly resist to impact. This has the consequence that the cell can survive this process without losing its vitality, and that the generated complex out of electrode and cell is extremely stable against mechanical influences.

Nano-Injection of DNA and/or Other Substances

The described contacting of the cell can also be used for nano- or micro-injection of bioactive substances into cellular systems.

For this purpose, the fakir electrodes are coated or layered beforehand with these substances. With substances which carry an electric charge (DNA), this can, for example, also take place by applying corresponding electric fields which generate forces on the particles and cause a movement to the surface of the fakir electrode. If the cell is subsequently contacted with the fakir electrode, the bioactive substance is in the cell. Advantages of this method are, on the one hand, the low usage of bioactive substance which is used to “seed” the cell, and the simple selection of the seeded cells from those to which nothing has been injected. The latter is possible if one exchanges the cell medium against a cell free medium after contacting and if one “harvests” the daughter cells of the seeded, contacted cells. By means of the measurement of the electric parameters of the contacted cells, furthermore the vitality status of the cells can be determined, and it is, thereby, possible to control the nutrition of the cells in an optimal way or to interrupt the harvesting process in case the contacted cells lose their vitality.

### Production of a Hybrid Sensor Head for the Electric Sampling

A further aspect of the present invention is the use of fakir electrodes for the direct or intercellular electric sampling.

For this purpose, it is necessary that the fakir electrode comprises a very high sealing resistance against the bath solution. It is insured thereby that the resistance measured from the fakir spike against the reference electrode (or other electric parameters of the system) is determined exclusively by the conductivity of the “cell” membrane of the cell contacted with the fakir electrode. Establishing a very high sealing resisting is, consequently, a very important part of our invention.

At first, the fakir electrode (or the fakir board electrode respectively) has to be electrically sealed off except of the tips of the fakir needles. It is described in (2) how this is achieved by our invention.

After contacting the fakir spikes with the above mentioned systems, it is necessary to seal off the surfaces of the fakir electrode which are exposed to the bath solution.
a) This can be done by a subsequent lipid coating of these exposed electrode surfaces.
b) It is another method, to attract liposomes (50 nm 1 μm) by means of appropriate high frequency alternating fields until all the electrode material is sealed off.

Theoretical explanation: This method is based on the fact that, on properly selected conditions, the dielectrophoretic forces only act on subjects of a defined diameter. Upon selection of appropriate frequencies, it is, therefore, possible to attract selectively subjects of small size (for example small liposomes of 50 nm to 1 μm) whereas large subjects (for example cells of 20 μm diameter) do not experience any force.

Also fusion of further cells or liposomes to the system which has already been contacted, can be used in order to put up the sealing resistance of fakir electrode. The fusion can be achieved by moderate μs-high-voltage pulses in order to melt several laterally and vertically dielectrophoretically arranged cells electrically to a product of fusion, so called electro fusion. Thereby “sensor heads” with large faultless membrane surfaces are simultaneously build.

By using electric cell cages, the process of contacting is to be automated.

### Electric Measurements at Hybrid Sensor Heads

The electric parameters of the cell may be evaluated by means of various electric methods:

a) Impedance method

b) Voltage clamp methods and

c) Current clamp methods.

In voltage clamp methods, it is necessary to use reversibly operating electrodes such as the Ag/AgCl-electrode. The chlorination of the silver fakir electrode should be done beforehand and, if necessary, also after contacting. In the latter case the chloride present inside the cells is used for this purpose. In order to avoid contaminations or disturbances with this process, the fakir electrode should by separated in this case from the zytosol by an intracellular salt bridge. This salt bridge can for example consist out of hydro-gels, for example alinate, which are doped with Cl-containing salts.

Depending on the method, different electrode materials have to be used (see (1) and (2)) in this respect). Different methods should be applied depending on the purpose:
a) Use of a single fakir electrode for contacting a cell,
b) Use of several fakir electrodes for contacting a plurality of cells.

In the latter case, the fakir electrodes should be sampled all together, on the one hand, and one by one, on the other hand.

The use of several fakir electrodes has in general the advantage that the downfall of one or several electrodes, for example because of eventual deposits of cytoplasm lipid and protein components or of membrane components upon the penetration, can be compensated on the base of the redundant system. The advantage of several, independently sampled fakir electrodes has the additional advantage that several different cells can be sampled in parallel simultaneously, and that, thereby, many results, independent from each other can be obtained while using extremely small solution volumina.

### Establishing the Long-Term Vitality of the Hybrid Sensor Head

For commercial applications of the invention presented herein, it is of importance not only to produce a mechanically sable system but to simultaneously maintain also the function of the system over a long period of time. The basic requirements therefore have already been explained above. A further measurement for putting up the mechanical stability of the complex out of fakir electrode and contacted cell, is the embedding of this complex (the “hybrid sensor head”) into a cross-linked hydro-gel matrix (which exists, for example, out of alginate matrix of cross-linked Ba²⁺-ions). This immobilization of the complex assures simultaneously a long term vitality of the complex and also facilitates the (cryo)conservation of the hybrid sensor head.

### Areas of Application of the Hybrid Sensor Head

The invention presented herein, could form a complementary supplement to existing electrophysiological technologies. It is supposed to be used in various variations. The background for this resides in the fact that for example the cross membrane resistance (an important electric parameter of the cell) depends on the ion channels in the membrane of a system, the electric conductivity of which maybe influenced or is influenced specifically by a broad spectrum of analytes (ligands, inhibitors and so on).

Therefore, the fakir technology can be used in screening tools (for example high-throughput drug target methods). For this purpose, so called targets (for example membrane proteins as ion channels, see above) are build into the membrane of the sensor head (for example by heterologous over-expression of proteins or doping with reconstructed proteins). Such hybrid sensor heads originating from fakir electrodes and contacted cells, allow the screening of a broad spectrum of active substances in analytical laboratories (“high-throughput-screening”, “lab-on-the-chip”) as well as under in-situ conditions (as “lab-in-the-probe” in a human/animal system and a plant-system). In addition to native cells, animal- and plant sensor cells should be used which can be tailored by means of specific heterogeneous over-expression of transporters or cell-cell- or cell-membrane fusion, respectively. Specifically designed sensor heads can be kept on stock as disposables for the universal electronic periphery. The sensor units can be produced individually as well as in form of micro-modules, comparable to micro titre plates. The latter configuration guarantees a very high degree of reliability of the analytic process by means of the possibility of redundant measurements with comparable sensor heads under identical measurement conditions. Furthermore, on using various tailor-made sensor heads on the same module, also complex determinations of multiple components in small probe volumina can be carried out with a high accuracy for example for the purpose of drug screening.

For in-situ applications, the sensor head has to be integrated into a probe—lab-in-the-probe—which allows the direct minimal invasive access to compartments filled with liquid of plant- or animal/human-systems. For the sampling of the signals and for the supply of the cells with appropriate media, the new sensor head technology should be combined with a miniaturized hose/pressure-sensor/catheter-system. For the fast and routine measurement of active substance concentrations in intact plants, the integration of the sensor head-/catheter-arrangement in a measurement automat according to the principle of a belt-hole pincer is also planned.

### Aspects of the Contacting Process

An important precondition to be able to successfully contact the cells, is the shape of the tip of the electrode spike 40s, and in particular the radius thereof or the curvature radius Ks at the distal end 40d of the electrode spike 40s, this should not be over 1/10 of the diameter Dz of the cell Z to be penetrated.

Furthermore, it is of advantage when the cell membrane M is under tension, i.e. the cell Z is filled. This can be achieved by use of none-iso-osmolar solutions into which the cells Z are incubated or which are used as measurement media 30.

For a successful contacting, it is, furthermore, helpful that—matching to the diameter Dz of the cell Z and to the distance of the cell Z from the fakir electrode 40s—the correct dielectrophoretic force is generated. The parameters for this process are selected for each cell-type independently from the above mentioned conditions. They are in the ranges stated. The application of a modulated alternating field, i.e. of an electric field which changes in a pre-programmed way during the attraction experiment, is not necessary but advantageous. The time-range for generating the attractive force is at about 10 μs to about 30 s.

The modulation of the alternating field can take place through the amplitude—lowering of the amplitude, for example as a ramp protocol, in particular linearly or exponentially—or through the frequency.

### Theoretical Background

The dielectrophoretic force is inversely proportional to the fifth power of the distance between the cell Z and the fakir electrode 40s. The attraction process is designed such that, at first, by choosing appropriate frequencies and high amplitudes, a relatively low force on the cell Z is generated. As the cell Z approached the electrode 40s, the force is increasing fast and the cell Z can be drastically accelerated—if the original field parameters are maintained. This can lead to a fast movement of the cell and to the destruction of the cell Z, for example by bursting, during the contacting. In contrast thereto, to low attraction forces result in that the cell Z is not penetrated by the fakir electrode 40s because the mechanical resistance of the membrane M of the cell cannot be overcome.

### Production of Fakir Electrodes

A further possibility to produce one kind of fakir electrodes cost-effectively in an industrial scale is the use of automated bonding machines. These are nowadays used mainly for contacting of computer boards/chips. Starting from a wafer out of an insulator material (plastics, glass and so on) which is provided with electrically contactable areas, these can individually be provided with a bonding wire. This bonding wire which is in contact with the electrically conductive sites of the “chip” on one side, can in a following step automatically be electrochemically etched at its second end by an accordingly automated application of electric fields. Alternatively an appropriate bonding procedure can be chosen which fixes the bonding wire having appropriate geometrical dimensions (length, thickness, tip) to the chip. The electrically conducting sites of the chip which should be sampled one by one, should have a diameter which is smaller than that of the cell used (or the fusion cell). This means, it should be, in a normal case, in the range from about 5 μm to about 100 μm. In case glass, for example borosilicate, is chosen as a carrier material, one has to expect that the cells make a very good contact (compared to patch-clamp-technology). This is also to be expected upon use of appropriate plastics materials. Techniques for subsequently removing insulation—as already described—can also be implemented if needed.

Automated Use of the Fakir Electrode in Combination with Cell Cages

The automated use of the fakir electrode in machine systems (sensor systems, high-throughput-systems and so on) should be achieved thereby that the chip carrying the fakir electrodes can be inserted into a micro-fluidic chamber. This chamber should assure appropriate systems based on the principle of electric cell cages, that cells can be positioned automatically and, in view of the signal fakir spikes, exactly opposite to the fakir electrodes. It should assure that the system can contact cells with automatically applied dielectrophorese protocols—as already described. The micro fluidic system should also allow the possibility of changing the solution.

### Further Aspects of the Electrochemical Production

In the following, possible conditions for the electrochemical etching are stated within the framework of an advantageous embodiment of the inventive production method.

### Preparing the Chips

The following are steps for preparing the chips:

Brake off a capillary of about 3 mm length, namely with a breaking edge having as small a size as possible.

Insert capillary in chip holder.

Mill the end of the capillary with fine sand paper, for example grit 1200, until the breakage edge is smooth and sharp.

Remove capillary and insert it reversed.

Mill the capillary end with fine sand paper, for example grit 1200, until the breakage edge is smooth and sharp.

Bring the capillary into the desired position.

Fix the capillary with ultraviolet glue.

Harden in a drying cabinet at 105° C. or under an ultraviolet lamp.

### Production of the Electrode (for Example Under a Binocular)

The following are steps for production of the electrode:

Cut off a wire piece, for example out of Ag, having a diameter of 25 μm for example at about 1.5 cm.

Flatten it on a clean surface, for example with the fingertip.

Clamp the chip blank into the chip holder.

Thread the wire piece through the glass capillary, for example with tweezers, and/or protruding to a maximum of 4 mm.

Anchor the back end of the wire on the metal of the chip holder, for example with conductor silver.

Let it dry for two minutes.

Thereafter, fix the chip holder for example to a micro manipulator.

Apply current clamp to the chip holder.

Thereafter the actual Electrochemical processing of the electrode (for example under a binocular) takes place.

### Electrochemical Processing of the Electrode

Fix end of wire in the middle of the field of vision.

Insert a drop of etching solution (for example perchloric acid: methanol=1:4) into the etching loop.

Apply voltage (for example 2V direct voltage, loop negative, wire positive).

Push the solution by means of thrust screws briefly over the end of wire and retracted directly.

Repeat this process until the desired shape of the spike is achieved. In such a way, the spikes are so to speak rasped under supervision.

Possibly further advance the wire with the screws of the chip holder

### Manufacturing Station—Layout-1-Chip

The following are steps for the manufacturing station for Layout-1-Chip:

Apply chip holder to the right manipulator.

Centre end of capillary in the field of vision.

Let the tip of wire be exposed by 1-2 mm and centre it in the capillary.

Move hood close.

Bring syringe with ultraviolet glue in position.

Allow glue to be drawn into the capillary by capillary forces, avoid splashing.

Carefully retract the wire and correct, therein, possibly the position until the wire tip projects still only a few μm (objective type: 40).

Switch on ultraviolet light for curing and observe the first two minutes. Correct, if necessary.

Change objective such that the chip is completely irradiated by ultraviolet light and let it cure half an hour.

### Finishing Step—Layout-1-Chip

The following is a description of the finishing step for Layout-1-Chip:

Take microscopic pictures of the tip.

Detach wire from the chip holder and connect end of wire to the metal of the chip by conducting silver.

Wait for 5 minutes.

Seal contact site with the ultraviolet glue, cure 1 h at 105° C. in a drying oven.

Insert completed chip into the chamber or store it until used.

### Manufacturing Station—Layout-2-Chips

The following is a description of the manufacturing station for Layout-2-Chips:

Attach chip holder to the right manipulator.

Apply chip to the holder of the left micro manipulator.

Bring drill hole into field of vision and centre left side of the chip in the field of vision.

Manoeuvre the tip of the wire through the drill hole of the chip by means of the right manipulator and the chip holder and let it project 1-2 mm.

Centre in bore hole.

Move hood close.

Bring tip with the ultraviolet glue into position.

Let glue be drawn into the bore hole by capillary forces, avoid splashing.

Carefully withdraw the wire until the tip of the wire still only projects a few μm (objective type: 40).

Switch on ultraviolet light for curing and observe the first two minutes.

Possibly correct.

Change objective such that the chip is completely illuminated by ultraviolet light, let cure half an hour.

Take microscopic pictures of the spike.

### Finishing Step Layout 2-Chips

The following is a description of the finishing step for Layout-2-Chips:

Detach wire from the chip holder and drip end of wire at the chip with conductive silver.

Insert finished chip into the chamber or store it until used.

In the following, some conditions are given in a Table which may be observed in the production of the spikes. The publications are given in detail in the section of the cited literature.

| Metal | Publication | Solution | Time | Current/voltage |
|---|---|---|---|---|
| Tungsten | (4) | NaOH, KOH | 20-50 min | DC: 5-12 V, |
| | | | | 60 mA |
| Gold | Ren et | HC1-ethanol | 6-7 min | DC: 2.2-2.4 V |
| | al., 2003 | | | |
| Silver | [1] | perchloric acid- | some | |
| | | methanol | seconds | |
| Platinum | [3] | KCN, NaC1 | | AC: 35 V |
| Iridium | | KCl, CaCl₂ | | |
| | | a.o. | | |
| Platinum | | diluted H₂SO₄ | | 15 V-pulses of |
| | | | | 16 μs-length, |
| | | | | 4 Hz; thereafter |
| | | | | 1-2 min. DC −1.1 |
| | | | | V |

These and further aspects of the present invention are explained in the following with reference to the attached drawings which show examples of embodiments of the invention.

FIG. 1 is a schematic and cut side view of a first embodiment of the inventive electrode arrangement with an electrode spike.

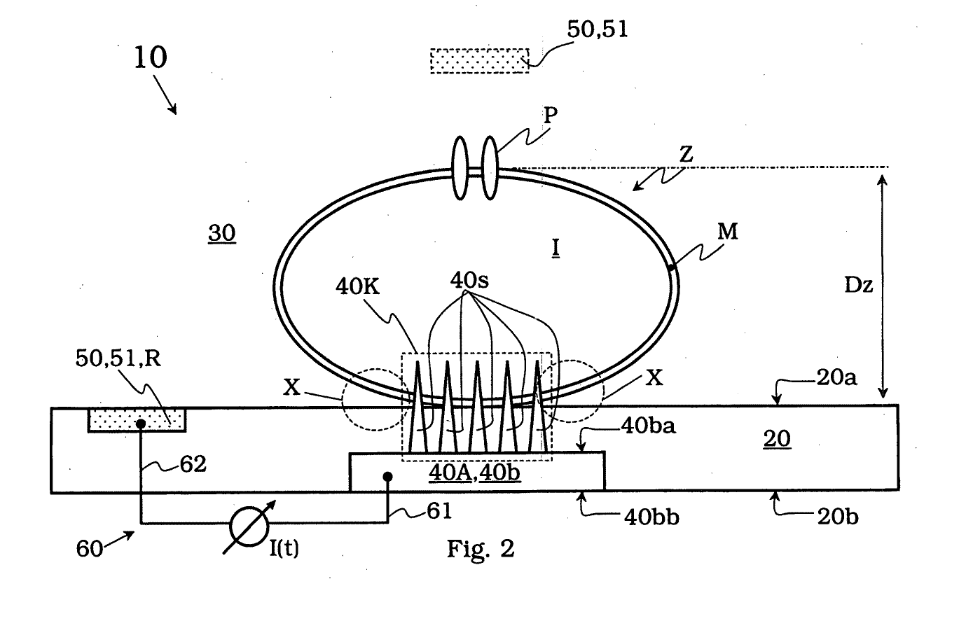

FIG. 2 is a schematic and cut side view of another embodiment of the inventive electrode arrangement with a plurality of electrode spikes.

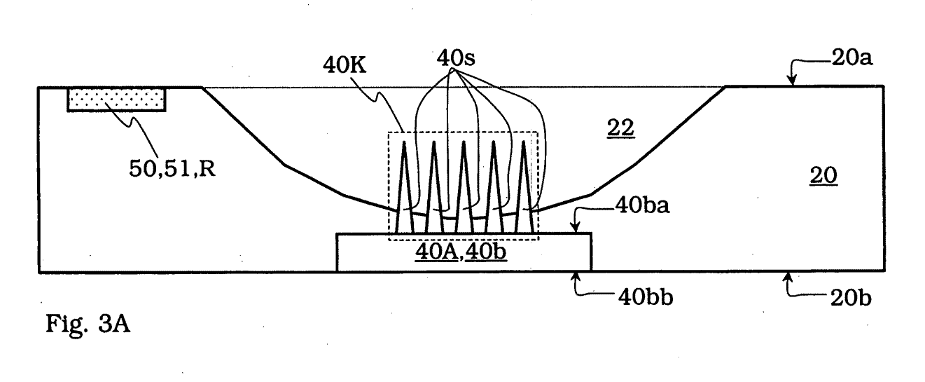

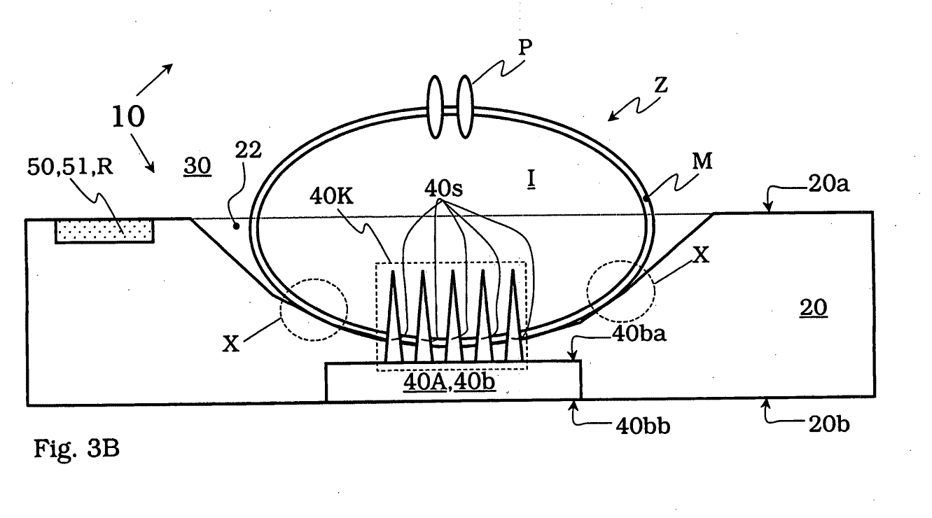

FIGS. 3A, 3B are schematic and cut side views of a further embodiment of the inventive electrode arrangement once with and once without contacted biological cell.

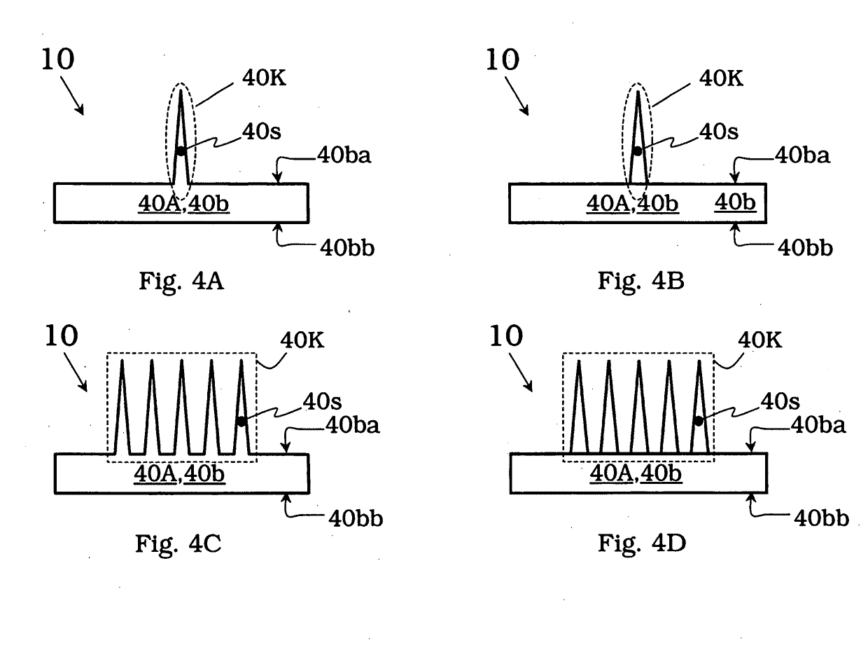

FIGS. 4A-4D are schematic and cut side views of various further embodiments of the inventive electrode arrangement.

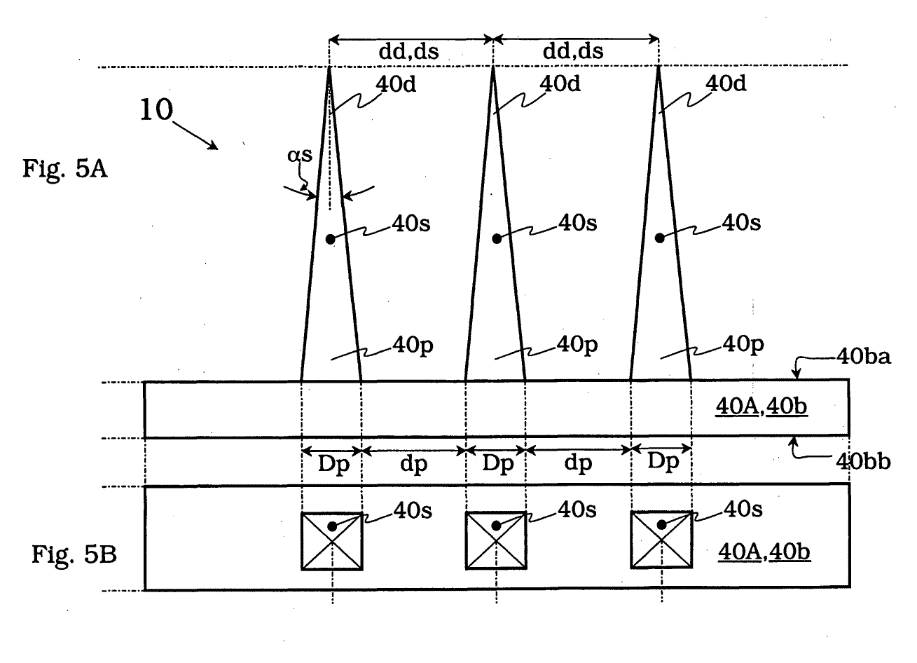

FIGS. 5A, 5B show, as a schematic and cut side view or a schematic top view of an embodiment of the inventive electrode arrangement, certain details of the invention.

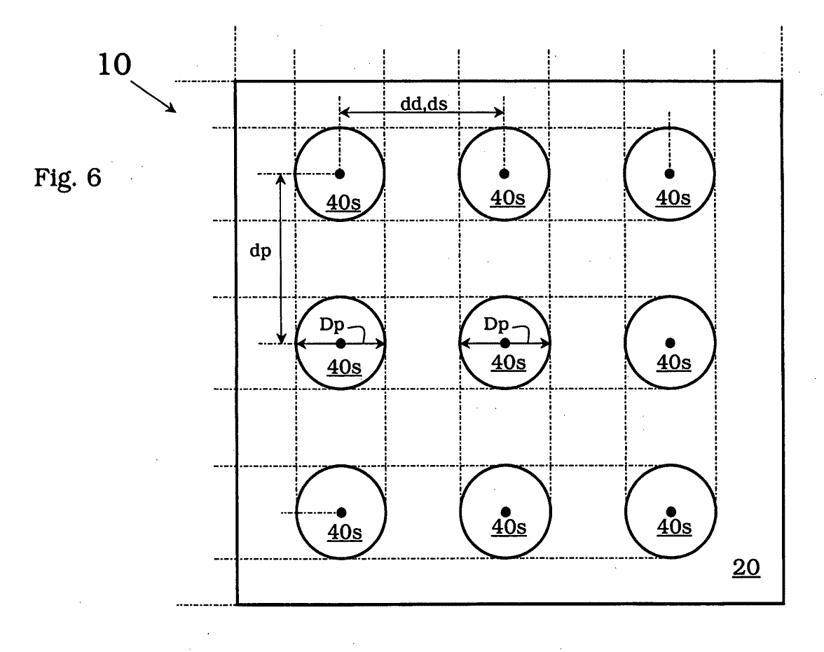

FIG. 6 is a schematic top view of a further embodiment of the inventive electrode arrangement.

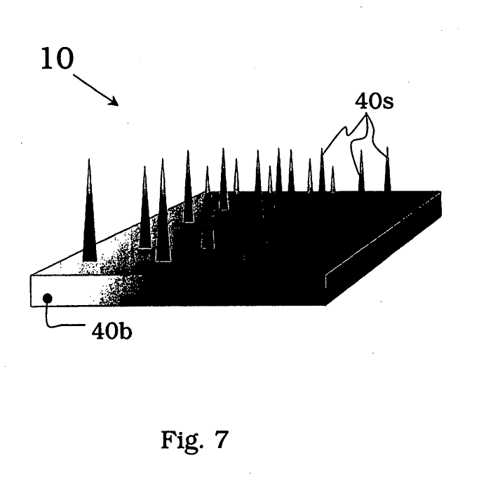

FIG. 7 is a schematic and cut side view of a further embodiment of the inventive electrode arrangement.

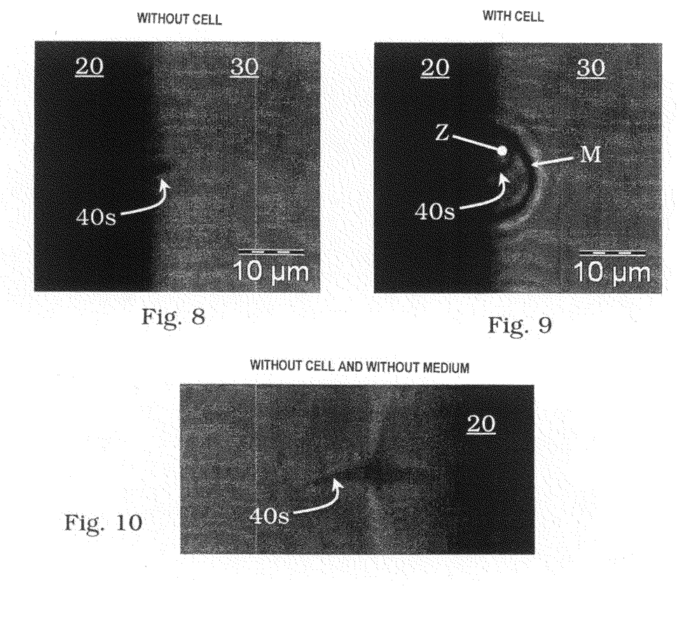

FIGS. 8-12 show, as microscopic pictures, certain applications which can be considered for the inventive electrode arrangement.

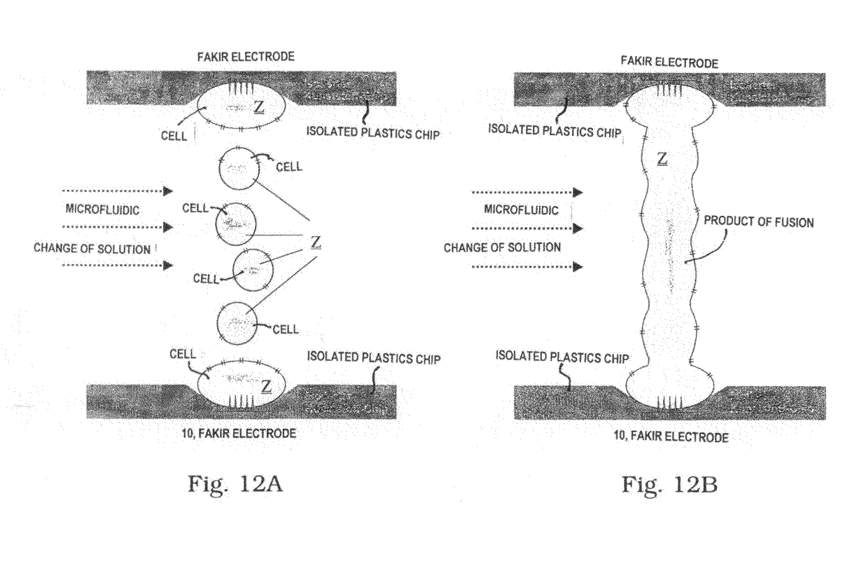

FIGS. 11A-12B show further applications of use of the present invention.

In the following, structures or method steps which are structurally and/or functionally similar or equivalent, are designated with the same designated characters. In each case of their occurrence, a detailed description of the structural elements or method steps is repeated.

### DETAILED DESCRIPTION OF THE PREFERRED EMBODIMENTS

FIG. 1 is a schematic and cut side view which describes a first embodiment of the inventive electrode arrangement 10 and the use thereof in the examination of a cell Z.

The embodiment of the inventive electrode arrangement 10 shown here, is based on a carrier 20 or a carrier substrate 20 having an upper surface 20a and a bottom side 20b. In the carrier 20, a contact area 40K is formed in part and the terminal area 40A is completely integrated, namely in such a way that the electrode spike 40s forming the contact area 40K of the electrode arrangement 10, is formed with its proximal end 40p facing the terminal area 40A completely below the upper surface 20a of the carrier 20, and with its distal end 40d which faces away from the terminal area 40A, formed strictly below the upper surface 40a of the carrier 40. The terminal area 40A is formed by a base 40b which forms an integral material area—here in the shape of a planar plate—, the upper side 40ba is contacted with the proximal and 40p of the electrode spike 40s and the bottom side 40bb of which is flush with the bottom side 40b of the carrier 20 and, thereby, allows an external contacting.

Through the contact area 40K with the electrode spike 40s and the distal end 40d thereof, electric sampling into the interior I of the contacted cell Z is done thereby that the distal end 40d of the electrode spike 40s penetrates through the cell membrane M into the interior I of the cell Z and provides by means of the conductivity of the electrode spike 40s, a corresponding electric sampling. Thereby, a current measurement or voltage measurement can be done through the outer measurement circuit 60 and the connecting conductors 61 and 62 such that charge carriers shifted by the trans-membrane protein P can be measured as corresponding shifting currents I(t) as a function of time wherein the electrode spike-40s is formed as a first electrode of the electrode arrangement 10 and a reference electrode R provided in the upper surface 20a, is formed as a corresponding second measurement electrode whereby the current circuit is closed by the appropriately provided, aqueous measurement medium 30.

Therein, it is important that a high electric sealing resistance is provided across the electrically insulated carrier 20 and the mechanical contact sites X between the cell Z and the carrier 20 in order not to short-circuit the electrode arrangement 10.

The reference electrode R may serve as measurement electrode as has been shown just before. It is also conceivable that this reference electrode R is used for the dielectrophoretic approach movement and contacting of the cell Z with the contact area 40K thereby that it forms a counter electrode 51 of a counter electrode arrangement 50.

Alternatively or additionally, the counter electrode arrangement 50 can also comprise a counter electrode 51 which is located opposite to the electrode spike 40s of the contact area as is shown by a broken line view.

The embodiment of FIG. 1 is defined with only one single electrode spike 40s in the contact area 40K.

However, embodiments are conceivable in which the contact area 40K of the electrode arrangement 10 is defined by a plurality of electrode spikes 40s of the same kind or having the same function.

The arrangement of FIG. 2 shows such an embodiment with a plurality of electrode spikes 40s of the same kind in the contact area 40K.

The embodiment of the inventive electrode arrangement 10 shown here, is based on a carrier 20 or a carrier substrate 20 with an upper surface 20a and a bottom side 20b. Again, a contact area 40K is integrated in part and a terminal area 40A is integrated completely in the carrier 20, and namely thereby that the electrode spike 40s forming the contact area 40K of the electrode arrangement 10, lies completely below the upper surface 20a of the carrier 20 with its proximal end 40p facing the terminal area 40A, and lies strictly above the upper surface 40a of the carrier 40 with its distal end 40d which is orientated facing away from the terminal area 40A. The terminal area 40A is also formed by a so-called base 40b which forms an integral material area the upper side 40ba of which is contacted with the proximal end 40b of the electrodes by 40s, and the bottom side 40bb of which is flush with the bottom side 40b of the carrier 20 and, thereby, again enables an external contacting.

Through the contact area 40K, here having a plurality of electrode spikes 40s, and the distal ends 40d of the plurality of electrode spikes 40s, and electric sampling into the interior I of a contacted cell Z takes place in that the distal ends 40d of the electrode spikes 40s penetrates through the cell membrane M into the interior I of the cell Z in they form, in this way, through the conductivity of the electrode spikes 40s as an electrode, a corresponding electric sampling. Thereby, through the outer measurement circuit 60 and the connecting conductors 61 and 62, a current measurement or voltage measurement can take place such that charge carriers drifted by the trans-membrane protein P, can be measured as corresponding shift currents I(t) as a function of time whereby the electrode spike 40s is formed as a first electrode of the electrode arrangement 10 and a reference electrode R provided in the upper surface 20a, is formed as a corresponding second measurement electrode whereby the current circuit is closed by the appropriately provided, aqueous measurement medium 30.

The reference electrode R can again serve as a measurement electrode. It is also again conceivable that this reference electrode R is used for a dielectrophoretic approach movement and contacting of the cell Z with the contact area 40K thereby that it forms a counter electrode 51 of a counter electrode arrangement 50. Alternatively or additionally, the counter electrode arrangement 50 can also comprise a counter electrode 51 which is arranged opposite to the electrode spikes 40s of the contact area as is shown by a broken line presentation.

The embodiment of the inventive electrode arrangement 10 shown in the FIGS. 3a and 3b differs from the embodiment which is shown in FIG. 2, only in that the upper surface 20a of the carrier 20 is not strictly planar but forms a concave depression 22, in particular in form of a recess, in the area of the electrode spikes 40s such that, as it becomes apparent from the transition from the state of FIG. 3A to the state of FIG. 3B, an approaching cell Z than nestles better at the upper surface 20a in the area of the recess 22 such that better sealing resistances at the sides X opposite to the provides measurement medium 30 are possible for avoiding short circuits.

The FIGS. 4A to 4D show, in a schematic and cut side view, different embodiments of the inventive electrode arrangement 10.

These embodiments are each shown without a carrier 20 or a carrier substrate 20 and they show only the contact area 40K in the form of one or several electrode spikes 40s and the terminal area 40a in the form of an integrally formed base 40b as a kind of planar plate having an upper side 40ba and a bottom side 40bb each.

In the embodiment of FIG. 4A one single electrode spike 40s is provided, which defines the contact area 40K of the electrode arrangement 10 and which is applied and contacted with its proximal end 40p at the upper side 40ba. The electrode spike 40s and the base 40b as a terminal area 40A are integrally formed.

In contrast thereto, it is shown in FIG. 4B that a single and separate electrode spike 40s which is to form the contact area 40K of the electrode arrangement 10, can also be applied in a subsequent process to the upper side 40ba of the base 40b such that a integrated structure results as is shown in FIG. 4B.

FIG. 4C shows also a one-piece embodiment of the inventive electrode arrangement 10, however, this time with a plurality of electrode spikes 40s, which are each formed on the upper side 40bb of the carrier 40b with their proximal ends.

In contrast thereto, an embodiment of the inventive electrode arrangement 10 is again shown in FIG. 4D in which no one-piece-structure is embodied between the electrode spikes 40s and the base 40b. Rather, the electrode spikes 40s, which are to form the contact area 40K of the electrode arrangement 10 of FIG. 4D, are applied to and electrically and mechanically contacted on the upper side 40ba in a subsequent process.

The embodiment of the inventive electrode arrangement 10 which is shown in the FIGS. 5A and 5B in the form of a schematic and cut side view or in the form of a schematic top view, respectively, shows a plurality of electrodes spikes 40s which are arranged in a row on the base 40b in form of a planar plate, and namely in a none-one-piece-way. Again, the distal ends 40d and the proximal ends 40p of the electrode spikes are also shown which are formed facing or facing away, respectively, from the upper side 40ba of the base 40b and which are in contact therewith. The electrode spikes 40s shown in the FIGS. 5A and 5B, comprise a length Ls and are equivalently spaced with equal distances dd, ds in pairs with respect to each other. Also their geometrical design is the same. This means that they have the same rectangular section with an edge length Dp and the corresponding diameter Dp in the area of the distal ends 40p. The electrode spikes 40s have the same length and extend while monotonous lead tapering up to their tip.

FIG. 6 shows an embodiment of the inventive electrode arrangement in which a plurality of electrode spikes 40s which forms a contact area 40K of the inventive electrode arrangement 10, are arranged in form of a rectangular matrix with an equal distance dd, ds from each other as well as an identical diameter Dp which here describes the diameter of the proximal end 40p having a circular cross section, of the respective electrode spike 40 s.

FIG. 7 shows an embodiment of the inventive electrode arrangement in which a kind of lawn of a plurality of electrode spikes 40s is provided on the base 40b of the electrode arrangement 10.

The FIGS. 8 to 10 show microscopic pictures of corresponding applications of the inventive electrode arrangement 10 having a single electrode spike 40s which is in contact with a test cell Z.

1-72. (canceled)

73. A process for electrophysiologically analysing or manipulating a species selected from the group consisting of biological cells, liposomes, vesicles, micellar structures, bacteria, viruses, fusion cells, organelles, genetic, microbiologic or biochemical derivatives thereof, components of these species and aggregates of these species with an electrode arrangement comprising:
a contact area for electrically contacting said electrode arrangement with at least one biological species; and
a terminal area electrically connecting said electrode arrangement;
wherein the contact area comprises at least one electrode spike as electrodes extending from the terminal area of the electrode arrangement; and
wherein the at least one electrode spike comprises a geometrical shape which allows an otherwise non-destructive penetration into the biological species through the membrane thereof into the interior thereof;
said process comprising the steps of:
supplying the species to be analysed or processed to the at least one electrode spike; and
exerting a force on the movement of the species to be analysed or processed to the at least one electrode spike for effecting the force transmission by a dielectrophoretic force.

74. A process for microinjecting a substance into a biological species selected from the group consisting of biological cells, liposomes, vesicles, micellar structures, bacteria, viruses, fusion cells, organelles, genetic, microbiologic or biochemical derivatives thereof, components of these substances and aggregates of these substances with an electrode arrangement comprising:
a contact area for electrically contacting the electrode arrangement with at least one biological species; and
a terminal area electrically connecting the electrode arrangement;
wherein the contact area comprises at least one electrode spike as electrodes extending from the terminal area of the electrode arrangement; and
wherein the at least one electrode spike comprises a geometrical shape which allows an otherwise non-destructive penetration into the biological species through the membrane thereof into the interior thereof,
said process comprising the steps of:
supplying the biological species to be analysed or processed to the at least one electrode spike; and
exerting a force on the movement of the biological species to be analysed or processed to the at least one electrode spike for effecting the force transmission by a dielectrophoretic force.

75. A process according to claim 74, and further comprising the step of:
charging the tip of the at least one electrode spike with the substance prior to microinjection.

76. A process according to claim 73, wherein the electrode arrangement is embedded in a micro-structure.

77. A process according to claim 73, wherein the electrode arrangement is provided in a lab-on-the-chip structure.

78. A process according to claim 73, wherein the electrode arrangement is provided in or for an assay, in particular for high-throughput applications.

79. A process according to claim 73, wherein the step of effecting the force transmission by a dielectrophoretic force comprises generating an inhomogeneous, electrical alternating field between the at least one electrode spike and a counter electrode arrangement with counter electrodes.

80. A process according to claim 79, wherein the step of generating an inhomogeneous, electrical alternating field comprises generating a high frequency field.

81. A process according to claim 73, wherein the step of generating the dielectrophoretic force comprises supplying the at least one electrode spike with an alternating voltage in the range of about 5 mV to about 300 V.

82. A process according to claim 81, wherein the step of generating the dielectrophoretic force further comprises supplying the at least one electrode spike with a frequency range of about 100 Hz to about 100 MHz.

83. A process according to claim 81, wherein the step of generating the dielectrophoretic force further comprises supplying the at least one electrode spike with a frequency range of about 100 Hz to about 60 MHz.

84. A process according to claim 81, wherein the step of generating the dielectrophoretic force further comprises supplying the at least one electrode spike with a frequency range of about 100 Hz to about 40 MHz.

85. A process according to claim 73, wherein the step of effecting the force transmission by a dielectrophoretic force comprises using an electrical cell cage for micro positioning the species during transmission of the dielectrophoretic force.

86. A process according to claim 73, and further including the step of firmly filling the species to be contacted by iso-osmolar solutions for facilitating the contacting of the species.

87. A process according to claim 73, done in an electrical insulation with free electrodes not contacted by cells, and further including flashing a solution of liposomes of defined size, wherein the minimum diameter is 100 nm and the maximum diameter is 5 μm, across the electrode surface and contacting the free electrode spikes with an alternating current.

88. A process according to claim 73, wherein a patch pipette or a patch electrode is used as an electrode spike or comprises an electrode spike.
